(19) United States
(12) Patent Application Publication
(10) Pub. No.: US 2024/0319782 A1
(43) Pub. Date: Sep. 26, 2024

(54) PROCESSOR FOR MANAGING POWER, POWER MANAGEMENT SYSTEM AND METHOD THEREOF

(71) Applicant: MEDIATEK Inc., Hsinchu City (TW)

(72) Inventors: Tse-Chung LI, Hsinchu City (TW); Tai-Ying JIANG, Hsinchu City (TW); Ching-Wen CHEN, Hsinchu City (TW); Shang-Wei CHEN, Hsinchu City (TW)

(21) Appl. No.: 18/605,933

(22) Filed: Mar. 15, 2024

Related U.S. Application Data
(60) Provisional application No. 63/491,324, filed on Mar. 21, 2023.

(51) Int. Cl. G06F 1/3296; G06F 1/3209

(52) U.S. Cl. CPC G06F 1/3296; G06F 1/3209

(57) ABSTRACT

The processor comprises multiple sub-systems. Each sub-system is configured to generate a voltage switching signal. The processor also comprises a packetizing module coupled to the sub-systems. The packetizing module packetizes multiple voltage switching signals generated by the sub-systems to a packet. The processor also comprises a PMIF (power management interface) configured to receive the packet and output the packet.

This application claims the benefit of U.S. provisional application Ser. No. 63/491,324, filed Mar. 21, 2023, the disclosure of which is incorporated by reference herein in its entirety.

### TECHNICAL FIELD

The disclosure relates in general to a processor for managing power, and more particularly to a power management system and a method of power management.

### BACKGROUND

To achieve low cost PMIC (power management integrated circuit) control, minimized interface sets is planned for each related products.

For example of single PMIC interface, if sub-systems of the system request to access PMIC at the same time, these commands need to go through an arbitration mechanism by predefined priority of each sub-systems, before push command on the interface. In the system with more sub-systems, the arbitration mechanism causes long latency. Thus, there are needs for achieving low cost and improving performance of power management for the system.

### SUMMARY

The present disclosure describes techniques for a processor for managing power, a power management system and a method thereof.

The first aspect of the present disclosure features a processor for managing power. The processor comprises multiple sub-systems. Each sub-systems is configured to generate a voltage switching signal. The processor also comprises a packetizing module coupled to the sub-systems. The packetizing module packetizes multiple voltage switching signals generated by the sub-systems to a packet. The processor also comprises a PMIF (power management interface) configured to receive the packet and output the packet.

In some implementations according to the first aspect of the present disclosure, the packet is outputted to a PMIC via a bus, and the voltage switching signals received by the packetizing module before the status of the bus changing from busy to ready are packetized to the packet by the packetizing module.

In some implementations according to the first aspect of the present disclosure, the PMIF includes a SPMI (system power management interface), and the voltage switching signals are packetized and/or encoded according to a SPMI protocol.

The second aspect of the present disclosure features a power management system. The power management system comprises a processor. The processor comprises multiple sub-systems. Each sub-systems is configured to generate a voltage switching signal. The processor also comprises a packetizing module coupled to the sub-systems. The packetizing module packetizes multiple voltage switching signals generated by the sub-systems to a packet. The processor also comprises a PMIF configured to receive the packet and output the packet. The power management system also comprises a PMIC which comprises a PMIC interface and an un-packetizing module coupled to the PMIC interface. The PMIC receives the packet outputted from the PMIF by the PMIC interface via a bus, and the un-packetizing module un-packetizes the packet to a command and multiple voltage switching data.

In some implementations according to the first or second aspects of the present disclosure, the packet is outputted to the PMIC after the status of the bus changes from busy to ready by the PMIF.

In some implementations according to the first or second aspects of the present disclosure, the PMIC further comprises multiple voltage switching circuits coupled to the un-packetizing module, and the voltage switching circuits of the PMIC provide power to at least one of the sub-systems according to the command and the voltage switching data generated from the packet un-packetized by the un-packetizing module.

In some implementations according to the second aspect of the present disclosure, each of the PMIF and the PMIC interface includes a SPMI, and the voltage switching signals are packetized and un-packetized, and/or encoded and decoded according to a SPMI protocol.

The third aspect of the present disclosure features a method for managing power of multiple sub-systems in a processor. The method includes receiving multiple voltage switching signals generated by the sub-systems. The method also includes packetizing the voltage switching signals to a packet. The method also includes sending the packet to a PMIC via a bus. The method also includes un-packetizing the packet to a command and multiple voltage switching data. The method also includes providing power, by the PMIC, to the sub-systems according to the command and the plurality of voltage switching data.

In some implementations according to the second or third aspects of the present disclosure, the voltage switching signals received by the packetizing module before the status of the bus changing from busy to ready are packetized to the packet by the packetizing module.

In some implementations according to the third aspect of the present disclosure, providing power to the plurality of the sub-systems according to the command and the voltage switching data incudes at least one of the voltage switching circuits provides power to the respective one of the sub-systems according to at least one of the voltage switching data.

In some implementations according to the first or third aspects of the present disclosure, the PMIC further comprises a PMIC interface and an un-packetizing module coupled to the PMIC interface. The PMIC interface is configured to receive the packet via the bus, and the un-packetizing module is configured to un-packetize the packet to a command and multiple voltage switching data.

In some implementations according to the third aspect of the present disclosure, sending the packetized signal to the PMIC via the bus is executed after the status of the bus changes from busy to ready by a PMIF of the processor.

In some implementations according to the first, second or third aspects of the present disclosure, the processor is a SoC (system on chip) and at least one of the sub-systems is at least one of: a CPU, a GPU, a modem, and a controller of a memory.

In some implementations according to the third aspect of the present disclosure, the bus is coupled between a PMIF of the processor and a PMIC interface of the PMIC, and each of the PMIF and the PMIC interface includes a SPMI, and the voltage switching signals are packetized and un-packetized, and/or encoded and decoded according to a SPMI protocol.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A illustrates an example system for power management, according to one or more implementations of the present disclosure.

FIG. 1B illustrates an example system for power management with a packetizing module and an un-packetizing module, according to one or more implementations of the present disclosure.

FIG. 2 illustrates a flowchart showing an example process for power management of a system, according to one or more implementations of the present disclosure.

FIG. 3 illustrates a flowchart showing another example process for power management of a system, according to one or more implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

A system, e.g., SoC, typically has multiple sub-systems; in order to keep performance, will add more PMIC interface sets to relieve arbitration latency. In order to keep performance, the arbitration priority of sub-systems will be adjusted, which may sacrifice performance of SRT (soft real-timey) sub-systems to satisfy HRT (hard real-time) sub-systems.

This disclosure provides techniques to manage the voltage switching signals (which can be also referred as dynamic voltage switching signals, DVS signals) generated by the sub-systems in a system (which can be also referred as a processor or a SoC), in which a packetizing module is designed for packetizing DVS from the systems to a packet while the bus between interfaces being busy. The packet includes a command and multiple voltage switching signals (which can be also referred as DVS data). Thus, these pending signals will not go through arbitration, and the packet will be outputted to the interface of PMIC (power management IC) via interfaces (such as power management interface of the system and interface of the PMIC) wile bus being ready. Since, the packet includes only one frame of command, packetized DVS will reduce lots of command frame which is needed in each transaction. Accordingly, total cycle needed to be done for all transaction will be reduced, and since that, the total power consumption will be reduced. Without conventional arbitration mechanism (zero arbitration latency), the performance of DVS signals transaction will be improved with minimized interface cost (without adding any additional interfaces).

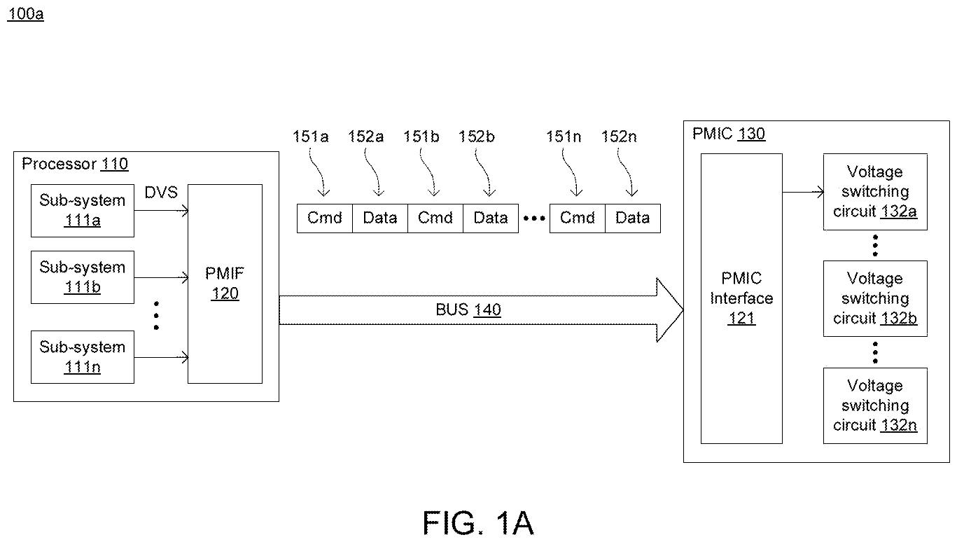

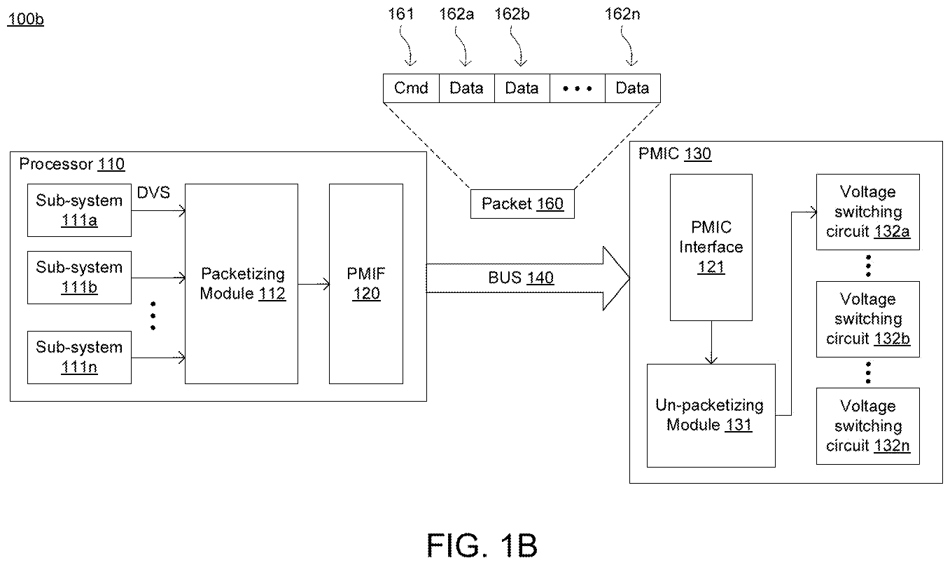

Please refer to FIG. 1A, which illustrates an example system 100a for power management, according to one or more implementations of the present disclosure. The system 100 comprises a processor 110 and a PMIC 130. The processor 110 includes sub-systems 111a-111n and a PMIF (power management interface) 120 coupled to the sub-systems 111a-111n. In some implementations, the processor can be a SoC (system on chip) and each of the sub-systems can be one of a CPU, a GPU, a modem, and a controller of a memory. When one or some of the sub-systems (such as sub-systems 111a, 111b or 111n) request for power supplying from the PMIC 130, DVS signals (or voltage switching signals) will be generated by those sub-systems (such as sub-systems 111a, 111b or 111n) and sent to the PMIF 120.

As shown in FIG. 1A, then the processor 110 outputs the DVS signals to the PMIC 130 from the PMIF 120. The PMIC 130 includes a PMIC interface 121 coupled to the PMIF 120 of the processor 110 via a BUS 140. Since the BUS 140 has limited bandwidth, the DVS signals not sent to the PMIC 130 yet will be put in arbitration queue while the BUS 140 being busy. In the arbitration mechanism, The DVS signals can be proceeded according to the predefined priority of each sub-systems (such as foresaid SRT or HRT). Since the DVS signals have certain size respectively including frames of command and data (such as Cmd frames 151a, 151b or 151n, and Data frames 152a, 152b or 152n), which might cost certain time to transfer a single DVS signals. Typically, 1.5 us is needed to send one set of command and data of single DVS signal between the PMIF 120 and the PMIC interface 121 via the BUS 140. Thus, when more sets of DVS signals needed to be sent to the PMIC 130, for example 5 sets of DVS signals, it will be cost almost 8 us and cause more latency since the bandwidth of BUS 140 is only capable of transferring the DVS signals one by one.

Therefore, one or some of the voltage switching circuits 132a-132n (voltage switching circuits can be also referred as bucks) of the PMIC 130 need to wait for the respective DVS signal being received, then provide power to the respective sub-system of the processor 110 according to the received DVS signal. In some implementations, one or more voltage switching circuits (such as one or some of voltage switching circuits 132a-132n) can provide power to respective sub-systems according to the DVS signal generated by the respective sub-system, for example, voltage switching circuit 132a can provide power to the sub-system 111b, or both voltage switching circuits 132a and 132b can provide power to the sub-system 111b at the same time, according to the DVS signal generated by the sub-system 111b.

With the number of DVS signals growing, more and more latency will occur which the requests from sub-systems will be delayed until the respective DVS signal is received by the respective voltage switching circuit after long waiting in queue. For example, when both of the sub-systems 111a (SRT) and 111b (HRT) request for power (or dynamic voltage switching) from the PMIC 130 by generating two DVS signals respectively, two DVS signals are sent to the PMIF 120 at the same time and put in arbitration queue. Since the sub-system 111b is HRT, the DVS signal of sub-system 111b is first to be outputted via the BUS 140 to the PMIC interface 121 (such as the Cmd frame 151a and the Data frame 152a), and the DVS signal of sub-system 111a which is SRT is held in the PMIF 120 (such as the Cmd frame 151b and the Data frame 152b). Due to the limited bandwidth of the BUS 140, it may cost 1.5 us for transferring the DVS signal (the Cmd frame 151a and the Data frame 152a) of sub-system 111b from the PMIF 120 to the PMIC interface 121, and the DVS signal (the Cmd frame 151b and the Data frame 152b) of sub-system 111a will be outputted by the PMIF 120 after at least 1.5 μs. Then, another at least 1.5 us is took for transferring the DVS signal (the Cmd frame 151b and the Data frame 152b) of sub-system 111a from the PMIF 120 to the PMIC interface 121, thus, for the requesting of the sub-systems 111a, it may take at least 3 us totally for PMIC 120 being capable to supply switching power to the sub-system 111a after receiving the DVS signal (the Cmd frame 151b and the Data frame 152b) of the subs-system 111a. So on, if more sub-systems send more DVS signals for requesting power (or dynamic power switching), more latency occurs for each requesting sub-systems due to their DVS signals (up to the Cmd frame 151n and the Data frame 152n) put on queue while the bus being busy.

Accordingly, some implementations use one or more different packetizing mechanisms to reduce Cmd frames which is needed in each transaction. These implementations will be described with reference to FIGS. 1B-4. For purposes of explanation, like numerals indicate like elements of FIG. 1A and FIG. 1B, and it should not be used to limit the present disclosure.

FIG. 1B illustrates an example system 100b for power management with a packetizing module 112 and an un-packetizing module 131, according to one or more implementations of the present disclosure. For purposes of explanation, the components of FIG. 1B, which are respectively similar to the components of FIG. 1A, are marked with the same respective reference number according to FIG. 1A. As shown in FIG. 1B, the differences are that the processor 110 further includes the packetizing module 112 coupled to the sub-systems 111a-111n and the PMIF 120, and the PMIC 130 further correspondingly includes the un-packetizing module 131 coupled to the PMIC interface 121 and the voltage switching circuits 132a-132n. The packetizing module 112 is configured to packetize DVS signals generated by one or some of the sub-systems 111a-111n to the packet 160 while the bus is busy. The packet 160 includes the Cmd frame 161 and data frames corresponding to those DVS signals packetized. Comparing to the examples of FIG. 1A which a Cmd frame and a data frame corresponding to each DVS signal, the packet 160 includes only one Cmd frame 161 corresponding to several DVS signals generated by one or some of the sub-systems 111a-111n, that are put on queue while the bus is busy.

For example, comparing to the examples of arbitration above, when more sub-systems (for example, the sub-systems 111c-111e, not shown) send more DVS signals for requesting power (or dynamic power switching) while the BUS 140 being busy (for transferring the precedent packet or operating other tasks), in response to determining that the BUS 140 is busy, the packet module 112 packetizes the received DVS signals generated by the sub-systems 111c-111e to the packet 160, which includes the Cmd frame 161 and data frames corresponding to the power switching request of the sub-systems 111c-111e respectively (for example, Data frame 162a is corresponding to the DVS signal of sub-system 111c, Data frame 162b is corresponding to the DVS signal of sub-system 111d and so on (not shown)). Then the packet 160 will be sent to the PMIC 130 through the PMIC interface 121 after the bus changing from busy to ready. In some implementations, the packetizing module 112 keeps receiving DVS signals generated by one or some of the sub-systems 111a-111n before the status of the BUS 140 changing from busy to ready, and, by the time of bus being ready, all the received DVS signals are packetizing to the packet 160 by the packetizing module 112 then outputted to the PMIC 130, such that DVS signals that have be done receiving by the packetizing module 112 will be included in the packet 160 and vice versa. After the PMIC 130 receiving the packet 160 outputted from the PMIF 120 by the PMIC interface 121 via the BUS 140, the un-packetizing module 131 un-packetizes the packet 160 to the command (corresponding to the Cmd frame 161) and DVS data (corresponding to one or some of the Data frames 162a-162n). Then, the respective one or some of the respective voltage switching circuits 132a-132n can provide power (or dynamic voltage switching, DVS) for the respective sub-systems 111c-111e (not shown) according to the command (corresponding to the Cmd frame 161) and DVS data (corresponding to one or some of the Data frames 162a-162n). So on, if more sub-systems send more DVS signals for requesting power (or DVS) while the BUS 140 being busy, the packetizing module 112 can keep packetizing those DVS signals to the following packet until the BUS 140 changing from busy to ready.

In some implementations, the PMIF 120 can include SPMI (system power management interface), and DVS signals received by the packetizing module 112 can be packetized and/or encoded to the packet 160 according to a SPMI protocol. Correspondingly, the PMIC interface 121 can also include SPMI (system power management interface), and the packet 160 received by the PMIC 130 can be un-packetized and/or decoded according to the SPMI protocol.

Accordingly, in such implementations, only one single Cmd frame which is needed in each transaction is used while packetizing the DVS signals put in queue, generated by the sub-systems while the bus is busy. The size of the packet 160 of FIG. 1B is significantly decreased comparing with the multiple Cmd frames and data frames corresponding to the DVS signals generated by the respective sub-systems. The latency of obtaining power (or DVS) from the respective voltage switching circuits of PMIC 130, requested by those sub-systems will be also decreased, since the command and DVS data corresponding to the DVS signals in the single outputted packet can be obtained by the respective voltage switching circuits almost the same time regardless of the priority of each sub-systems.

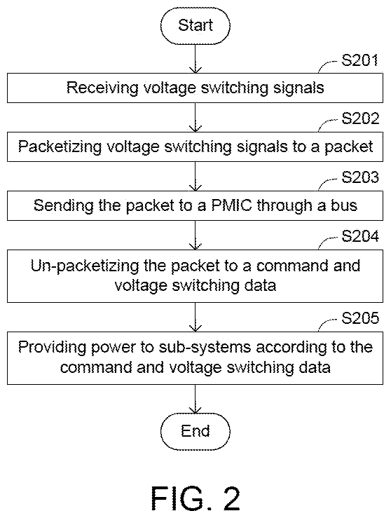

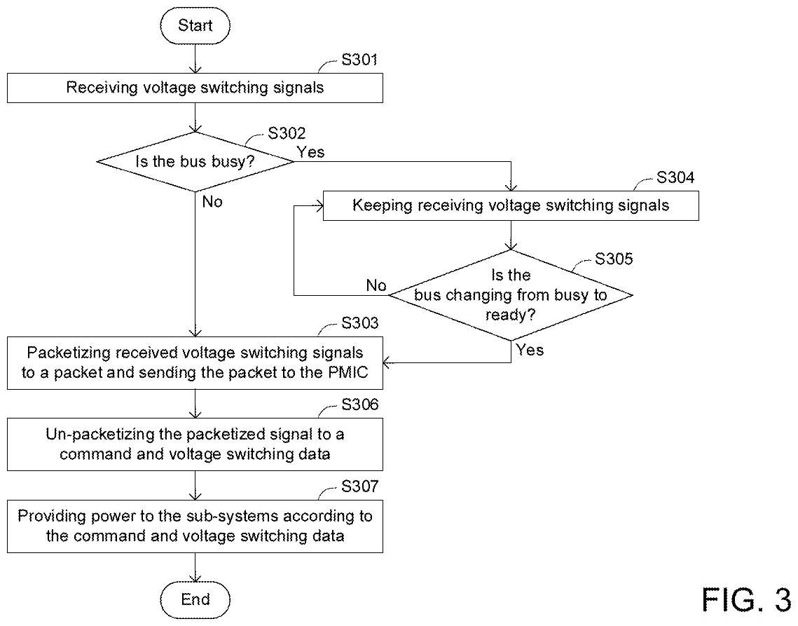

The steps of operations discussed above will be described in further detail herein referring with FIGS. 2 and 3 as follows.

FIG. 2 illustrates a flowchart showing an example process 200 for power management of a system, according to one or more implementations of the present disclosure. The process 200 can be performed by a system for managing power for its components. One or more steps of the process 200 are similar to the operations described with reference to FIG. 1B.

At S201, a packetizing module (such as packetizing module 112 of FIG. 1B) receives voltage switching signals (or DVS signals). The voltage switching signals (or DVS signals) can be generated by sub-systems of a processor (such as the sub-systems 111a-111n of the processor 110 of FIG. 1B).

At S202, the packetizing module packetizes voltage switching signals (or DVS signals) to a packet (such as packet 160 of FIG. 1B). For examples, the packetizing module can packetize received voltage switching signals (or DVS signals) to a packet while a BUS (such as BUS 140 of FIG. 1B) is busy as discussed above.

At S203, the processor sends the packet to a PMIC (such as PMIC 130 of FIG. 1B) through a bus. For examples, the processor can send the packet to the PMIC via a PMIF and a PMIC interface (such as PMIF 120 and PMIC interface 121 of FIG. 1B) after the BUS changing from busy to ready as discussed above.

At S204, an un-packetizing module (such as un-packetizing module 131 of FIG. 1B) of the PMIC un-packetizes the packet to a command and voltage switching data (can be corresponding to, for example, Cmd frame 161 and data frames 162a-162n of FIG. 1B). As discussed above, the command and the voltage switching data can be then sent to voltage switching circuits (such as voltage switching circuits 132a-132n of FIG. 1) coupled to the un-packetizing module in the PMIC.

At S205, the voltage switching circuits of PMIC provide power to the respective sub-systems according to the command and voltage switching data. As discussed above, the command and voltage switching (or DVS) data can be used as references for voltage switching circuits (such as voltage switching circuits 132a-132n of FIG. 1) to provide power (or DVS) to the requesting sub-systems of the processor. In some implementations, the process 200 moves to end if there is no voltage switching signal being received.

FIG. 3 illustrates a flowchart showing another example process 300 for power management of a system, according to one or more implementations of the present disclosure. The process 300 can be performed by a system for managing power for its components. One or more steps of the process 300 are also similar to the operations described with reference to FIG. 1B.

At S301, which is similar with S201 of FIG. 2, the packetizing module receives voltage switching signals. The difference is that, at S302, the processor or the packetizing module can determine that whether the BUS between the processor and the PMIC is busy or not. If no (which means the BUS is ready or not busy), process 300 moves S303, which is similar with S202 and S203 of FIG. 2, and the description thereof is omitted here. If yes, (the BUS is busy), process 300 moves S304, which the packetizing module keeps receiving voltage switching signals while the BUS being busy.

Similarly with S302, at S305, the processor or the packetizing module can determine that whether the bus is changing from busy to ready or not. If no (the bus is still busy), the packetizing module keeps receiving coming voltage switching signals while the BUS being busy. If yes (the bus is changing from busy to ready), the process 300 moves to S303, the packetizing module packetizes all the received voltage switching signals to the packet and sending the packet to the PMIC. As discussed above, such that voltage switching (or DBS) signals that have be done receiving by the packetizing module will be included in the packet sent to the PMIC and vice versa.

Then process 300 moves to S306 and then S307, which are similar with S204 and S205 of FIG. 2, and the descriptions thereof are omitted here.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A processor for managing power, comprising:
a plurality of sub-systems, wherein each of the plurality of sub-systems is configured to generate a voltage switching signal;
a packetizing module, coupled to the plurality of the sub-systems, wherein the packetizing module packetizes the plurality of voltage switching signals generated by the plurality of the sub-systems to a packet; and
a PMIF (power management interface), configured to receive the packet and output the packet.

2. The processor according to claim 1, wherein the packet is outputted to a PMIC via a bus, and the plurality of voltage switching signals received by the packetizing module before the status of the bus changing from busy to ready are packetized to the packet by the packetizing module.

3. The processor according to claim 2, wherein the packet is outputted to the PMIC after the status of the bus changes from busy to ready by the PMIF.

4. The processor according to claim 1, wherein the PMIC further comprises a PMIC interface and an un-packetizing module coupled to the PMIC interface,
wherein the PMIC interface is configured to receive the packet via the bus, and the un-packetizing module is configured to un-packetize the packet to a command and a plurality of voltage switching data.

5. The processor according to claim 4, wherein the PMIC further comprises a plurality of voltage switching circuits coupled to the un-packetizing module, and the plurality of voltage switching circuits of the PMIC provide power to at least one of the plurality of the sub-systems according to the command and the plurality of voltage switching data generated from the packet un-packetized by the un-packetizing module.

6. The processor according to claim 1, the processor is a SoC (system on chip) and at least one of the plurality of sub-systems is at least one of:
a CPU, a GPU, a modem, and a controller of a memory.

7. The processor according to claim 1, wherein the PMIF includes a SPMI (system power management interface), and the plurality of voltage switching signals are packetized and encoded according to a SPMI protocol.

8. A power management system, comprising:
a processor, comprising:
a plurality of sub-systems, wherein each of the plurality of sub-systems is configured to generate a voltage switching signal;
a packetizing module, coupled to the plurality of the sub-systems, wherein the packetizing module packetizes the plurality of voltage switching signals generated by the plurality of the sub-systems to a packet; and
a PMIF configured to receive the packet and output the packet; and
a PMIC comprising a PMIC interface and an un-packetizing module coupled to the PMIC interface,
wherein, the PMIC receives the packet outputted from the PMIF by the PMIC interface via a bus, and the un-packetizing module un-packetizes the packet to a command and a plurality of voltage switching data.

9. The power management system according to claim 8, wherein the plurality of voltage switching signals received by the packetizing module before the status of the bus changing from busy to ready are packetized to the packet by the packetizing module.

10. The power management system according to claim 9, wherein the packet is outputted to the PMIC after the status of the bus changes from busy to ready by the PMIF.

11. The power management system according to claim 8, wherein the PMIC further comprises a plurality of voltage switching circuits coupled to the un-packetizing module, and the plurality of voltage switching circuits of the PMIC provide power to at least one of the plurality of the sub-systems according to the command and the plurality of voltage switching data generated from the packet un-packetized by the un-packetizing module.

12. The power management system according to claim 8, wherein the processor is a SoC (system on chip) and at least one of the plurality of sub-systems is at least one of:
a CPU, a GPU, a modem, and a controller of a memory.

13. The power management system according to claim 8, wherein each of the PMIF and the PMIC interface includes a SPMI (system power management interface), and the plurality of voltage switching signals are packetized and un-packetized, and/or encoded and decoded according to a SPMI protocol.

14. A method for managing power of a plurality of sub-systems in a processor, comprising:
receiving a plurality of voltage switching signals generated by the plurality of the sub-systems;
packetizing the plurality of voltage switching signals to a packet;
sending the packet to a PMIC via a bus;
un-packetizing the packet to a command and a plurality of voltage switching data; and
providing power, by the PMIC, to the plurality of the sub-systems according to the command and the plurality of voltage switching data.

15. The method according to claim 14, wherein the plurality of voltage switching signals received by a packetizing module of the processor before the status of the bus changing from busy to ready are packetized to the packet by the packetizing module.

16. The method according to claim 14, wherein sending the packetized signal to the PMIC via the bus is executed after the status of the bus changes from busy to ready by a PMIF of the processor.

17. The method according to claim 14, wherein the PMIC further comprises a PMIC interface and an un-packetizing module coupled to the PMIC interface,
wherein the PMIC interface is configured to receive the packet via the bus, and the un-packetizing module is configured to un-packetize the packet to the command and the plurality of voltage switching data.

18. The method according to claim 17, wherein providing power to the plurality of the sub-systems according to the command and the plurality of voltage switching data incudes at least one of the plurality of voltage switching circuits provides power to the respective one of the plurality of the sub-systems according to at least one of the plurality of voltage switching data.

19. The method according to claim 14, wherein the processor is a SoC (system on chip) and at least one of the plurality of sub-systems is at least one of:
a CPU, a GPU, a modem, and a controller of a memory.

20. The method according to claim 14, wherein, the bus is coupled between a PMIF of the processor and a PMIC interface of the PMIC, and each of the PMIF and the PMIC interface includes a SPMI, and the plurality of voltage switching signals are packetized and un-packetized and/or encoded and decoded according to a SPMI protocol.
